(19) United States
(12) Patent Application Publication
(10) Pub. No.: US 2007/0101882 A1
(43) Pub. Date: May 10, 2007

(54) Polychrome rotary press

(76) Inventors: Martin Krumpelmann, Lengerich (DE); Manfred Loddenkotter, Ibbenburen (DE)

Correspondence Address: JACOBSON HOLMAN PLLC, 400 SEVENTH STREET N.W., SUITE 600, WASHINGTON, DC, 20004, US

(21) Appl. No.: 10/555,956

(22) PCT Filed: May 6, 2004
(86) PCT No.: PCT/EP04/05127

§ 371 Date: Nov. 7, 2005

(30) Foreign Application Priority Data
May 7, 2003 (DE) 103 20 205.6

(51) Int. Cl. B41F 13/24

(52) U.S. Cl. 101/248

(57) ABSTRACT

The present invention describes a multi-color rotary printing machine in which one printing plate support (1) each is assigned to the colors that are transferred onto the print substrate. This printing plate support (1) supports a printing plate (6) and can be attached to a mandrel or a cylinder (5) of a rotary printing machine in order to transfer the print image onto the print substrate. The rotary printing machine has register devices (6, 7, 8) that determine the position of the printing plates (6) with respect to one another and comprise sensors (3) that determine the positions of the printing plate support (1) in the printing machine.

Furthermore, the present invention describes and claims printing plate supports (1) that form a system together with the printing machine according to the invention. Processes for operating printing machines according to this invention are also the subject of the matter for which protection is sought.

This is a nationalization of PCT/EP04/005127 filed May 6, 2004 and published in German.

The present invention relates to a multi-color rotary printing machine
in which one printing plate support each is assigned to the colors to be transferred onto the print substrate, whereby said printing plate support supports a printing plate and
can be attached to a mandrel or a cylinder of a rotary printing machine in order to transfer the print image onto the print substrate,
whereby the rotary printing machine has register devices that determine the position of the printing plates with respect to one another.

Machines of such type are designed, for example, as flexographic printing machines and gravure printing machines. The term “printing plate support” refers to all possible cylinders, sleeves, or even flexible mats that support a printing plate. Thus, for example, a cylinder that supports a printing plate and is supported using bearing pins and/or bearing points is used conventionally in gravure printing. However, in recent times the so-called sleeves that are drawn up over a cylinder are also used in gravure printing just as in case of flexographic printing. Many different colors are used particularly in package printing. As a result, the high demands made on register accuracy play an important role in this context. However, register accuracy also plays an important role in other areas and in the application of other print processes. The still unpublished patent application having the file number 102 54 836. 6-27 and that has also been submitted to the German Patent and Trademark Office addresses this issue of register processes in detail.

In the literature relevant to this subject, no mention is usually made of the manner in which the positions of the printing plate supports with respect to one another are determined before and at the time of the start of the print process. Said positions are determined, for example, in flexographic printing machines of prior art by an alignment of the printing plate—usually an alignment of a printing sleeve to a pin protruding in the radial direction over the peripheral surface of the print cylinder.

The printing sleeve has a recess into which the pin fits with relative accuracy. It is a laborious and time-consuming process for the machine operator to align the printing sleeve correctly. This process is often referred to as pre-register control.

In addition to that, the clearance between the pin and the recess results in inaccuracies during the register control.

This clearance strongly increases in direct proportion to the service life particularly of printing plate supports of flexographic printing that are manufactured from plastic and are often replaced. Register errors can often occur and/or multiply even during the ongoing operation if printing plates, while in operation, shift on the mandrels or the cylinders on which they are seated.

A more accurate pre-register control of the sleeve that could reduce the said disadvantages also forms the subject matter of the patent application U.S. Pat. No. 5,551,339. Said document illustrates a printing machine that is provided with sensor devices which observe the peripheral surface of the printing sleeves. Information carriers are located on the peripheral surface of the printing sleeves. The position of the information carriers is recorded after the sleeves are inserted into the machine and before the start of the actual printing operation. After the angle position of the sleeve on the mandrel on which it is located is determined, the torque-proof connection between the mandrel and the sleeve is broken, the sleeve is grasped by a frame-fixed gripping devices and prevented from bringing about a rotation of the mandrel. Subsequently, the sleeve being stationary, the mandrel is rotated in such a manner that a relative target position between the sleeve and the mandrel sets in. The patent application U.S. Pat. No. 6,314,883 also describes a process of pre-register control in which an information carrier attached to the sleeve and a sensor are specified for recording the position of said sleeve.

The objective of the present invention is to improve the accuracy and the quality of this register process.

Said objective is achieved by the characteristic features of claims 1 and 6.

The measures according to the present invention can effectively prevent the information carriers, for example in case of optical sensors, from getting smudged and consequently resulting in register inaccuracies. The information carriers can get smudged and result in such register inaccuracies even in the case of magnetic or electromagnetic sensors. An additional advantage is that in case of all types of sensors, it is possible to prevent damages to the information carriers resulting from the print and the filling in the print image

The following specifications are useful in promoting an understanding of the present invention.

The sensors of the register devices can comprise markings, data carriers or the like, referred to in the following as information carriers that are specially intended for this purpose. The simplest form of an information carrier is a simple line-shaped marking. However, these sensors can also scan characteristic surface features of conventional printing plate supports that are not loaded with information carriers—such as the raised edge of a printing plate used in flexographic printing.

The positions of the printing plates can be made accessible to the machine operator, for example, using a suitable interface such as a display, a monitor or a printer. The machine operator can then make corrections in the positions of the printing plates with respect to one another. For this purpose, he will, in the known fashion, manually adjust the drive connections between the drive and the print cylinders or the printing mandrels in case of the longitudinal register adjustment in a printing machine that is equipped with only one drive. In case of directly driven machines that have been disclosed in the patent application Ca 12 23 150, the machine operator can make such adjustments by a corresponding control of the drives driving the respective mandrels or cylinders.

It proves to be advantageous if a control unit carries out said control.

A printing plate support is known from the patent application DE 297 20 928 U1.
that supports a printing plate and that can be attached to the mandrel or the cylinder of a rotary printing machine in order to transfer the print image onto the print substrate and
that contains at least one information carrier from which information can be removed using a read-out device.

In this connection, the printing plate support is a sleeve, the information carrier is a transponder chip and the information stored on the chip characterizes the print image and is related to the printing sleeve itself (print image, color, age etc.). Information of such type is also often imprinted on printing sleeves in the form of plain text or bar codes. Printing plate supports form a system together with a rotary printing machine according to the present invention if

the information that can be read out automatically is suitable for determining the relative position of the printing plate support on the mandrel or the print cylinder of a rotary printing machine.

Preferred types of arrangement of the information carrier have been specified in the dependent claims. As mentioned earlier, information carriers can also be distinct as pronounced markings on the periphery of the printing plate support. Such markings can be present as notches or coloring in the material of the printing plate support and can be detected using optical sensors. However, this purpose can also be achieved by using a metal strip that is fixed in the material of the printing plate support and that can be detected using a suitable electromagnetic sensor. If such simple markings are designed as a line or a point, they can supply a small amount of information during a rotation of the printing plate support. However, this information is basically sufficient for determining the angle position of the printing plate support in the peripheral direction (longitudinal register) and the axial position of the printing plate support on the print cylinder and/or on the mandrel (transverse register). However, information carriers that are stretched over large areas of the peripheral surface in the peripheral direction are preferred. Such information carriers can be loaded with larger amounts of information and it is possible that the sensor can record the exact position of the printing plate over a large angular range of the rotation of the printing plate around the mass centroid axis of the mandrel or the print cylinder. This additional information can benefit the quality of the longitudinal register.

Optically recognizable markings can get smudged in the printing operation until it is no longer possible for the sensors to detect them. Therefore, information carriers such as magnetic tapes, transponder dipole chains, sequences of suitable metal structures etc. that can be read out magnetically or electromagnetically are preferred.

The register quality can be increased further if, in addition to the position of the printing plate support, the position of the print substrate is also recorded and used for register control. This is feasible using the processes that are known from prior art and in which the print substrate is provided with register markings whose position is recorded by sensors. For the purpose of studying this process, reference is made again to the still unpublished patent application having the file number 102 54 836.6-27 that has been submitted to the German Patent and Trademark Office.

If information is available both regarding the position of the printing plates as well as the position of the print substrate in the printing machine, it is also possible to take into account, during the register control, additional factors influencing the print quality that stem from a change in the condition of the print substrate (e.g. fan-out and web elongation).

Additional embodiments of the present invention are explained in the present description and in the claims.

Since printing machines per se are known, this description does not contain an illustration of an entire printing machine or of the installation position of a printing plate support according to this invention in a printing machine according to this invention.

In this context, for the purpose of an example, reference has been made once again to the documents cited above and the patent application DE 101 45 957.2 A1. Printing machines known from prior art and register processes are illustrated in these documents. Only a sensor 3 must be inserted into such printing machines in such a manner that it can detect the position of the printing plate support 1 in the printing machine. The figures illustrate:

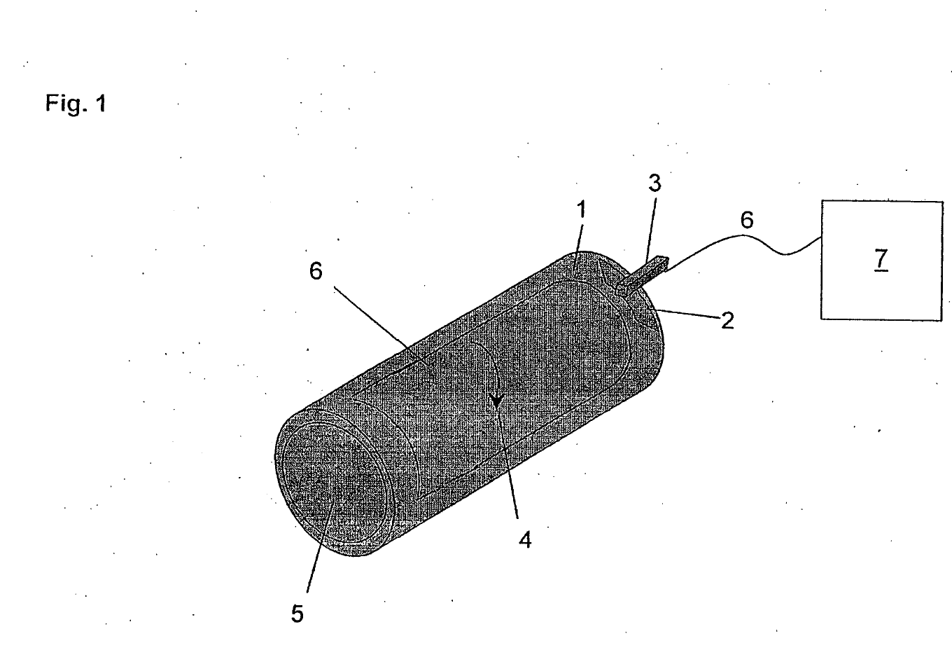

FIG. 1: a diagram of a printing plate support according to the present invention

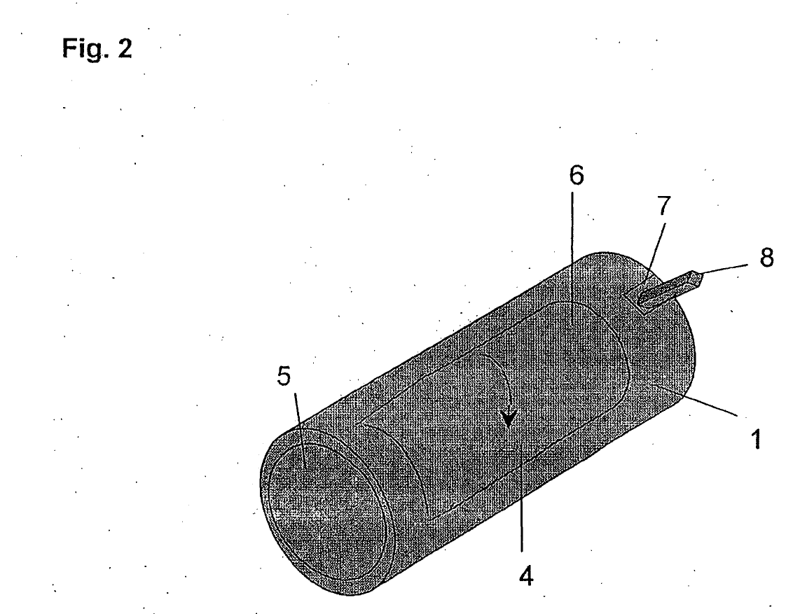

FIG. 2: a diagram of a printing plate support according to prior art.

FIG. 1 illustrates schematically the arrangement of an embodiment of a printing plate support 1 according to the present invention that has an information carrier 2. In this embodiment, the information carrier is an intentionally shaped magnetic tape 2 that is embedded into the printing plate support 1. However, linear magnetic tapes are usually preferred. The sensor 3 is attached at an appropriate place of the printing machine that is not illustrated here. It 3 is suitable for reading out the magnetic tape 2. The sensor 3 transmits an analog signal over the signal line 6 to the control device 7 of the printing machine which subjects the signal to an analog/digital transducer and takes into account the information contained when generating register correction signals for the drives of the printing machine.

The greatest advantage of this embodiment is the simplification of the pre-register control that is carried out according to prior art as mentioned above with the help of a pin. However, the information that is read out from the sensor 3 can also be consulted during the ongoing print process in order to improve the register control. The figure also illustrates that the printing plate support 1 is a printing sleeve that is drawn up on the print cylinder 5 of the printing machine in the printing operation. Such arrangements are known in flexographic printing. However, they are also used in recent times in gravure printing.

The printing sleeve and/or the printing plate support supports the printing plate 6. In this embodiment, the information carrier is arranged between the edge of the printing plate 6 and a front edge of the sleeve 1.

The arrow 4 indicates the direction of rotation of the print cylinder 5.

FIG. 2 illustrates a printing plate support 1 according to prior art that is provided with a recess 7. The printing plate support is designed as a sleeve that is drawn up on the print cylinder 5. When drawing up the printing sleeve on the print cylinder, the machine operator must ensure that the recess 7 accommodates the register pin 8 of the cylinder 5=that protrudes over the peripheral surface of the print cylinder in the radial direction. Only then can a satisfactory pre-register control be ensured according to prior art.

List of Reference Symbols

| | |
|---|---|
| 1 | Printing plate support |
| 2 | Sensor |
| 3 | Sensor |
| 4 | Arrow |
| 5 | Cylinder |
| 6 | Printing plate |
| 7 | Recess |
| 8 | Register pin |
| 9 | |
| 10 | |
| 11 | |
| 12 | |
| 13 | |
| 14 | |
| 15 | |
| 16 | |
| 17 | |
| 18 | |
| 19 | |
| 20 | |
| 21 | |
| 22 | |
| 23 | |
| 24 | |

1. Multi-color rotary printing machine,
in which one printing plate support (1) each is assigned to the colors to be transferred onto the printing plate, whereby said printing plate support (1) supports a printing plate (6) and
said printing plate support (1) can be attached to a mandrel or a cylinder (5) of a rotary printing machine in order to transfer the print image onto the print substrate,
whereby the rotary printing machine has register devices (6, 7, 8) that determine the positions of the printing plates (6) with respect to one another and
whereby the register devices (6, 7, 8) comprise sensors (3) that determine the positions of the printing plate support (1) in the printing machine and
whereby the register devices (6, 7, 8) provide information regarding the positions of the printing plate support (1) before, at the start of or during the print process with the help of sensors (3),
based on which control signals can be provided,
whereby the register devices (6, 7, 8) comprise a control device (7) using which it is possible to generate control signals based on the positions of the printing plate support (1) determined by the sensors (3) and it is possible to control the drives of the mandrels or the print cylinders (5) using said control signals in such a manner that the phase position of the mandrels or the print cylinders (5) in relation to one another can be changed,
and the register accuracy of the print increases,
and whereby each printing plate support (1) contains at least one information carrier (2) from which information can be removed using a sensor (3), whereby the information that can be read out automatically is suitable for determining the relative position of the printing plate support on the mandrel or on the print cylinder (5) of a rotary printing machine,
characterized in
that the information carrier (2) is arranged outside the printing mandrel (6) and
that the information carrier (2) is arranged between the print image (6) and the edge of the printing plate support that is turned toward the front end of the mandrel or of the print cylinder (5).

2. Multi-color rotary printing machine pursuant to the afore-mentioned claim characterized in that the information carrier (2) has an oblong, preferably rectangular shape whereby its long side is essentially aligned in the peripheral direction of the printing plate support.

3. Printing plate support pursuant to claim 1 characterized in that the information carrier (2) surrounds the periphery of the mandrel or the cylinder (5) of the printing machine.

4. Printing plate support pursuant to claim 1 characterized in that the information stored on the information carrier can be read out optically, magnetically or electromagnetically.

5. Printing plate support pursuant to claim 1 characterized in that the information carrier (2) comprises a magnetic tape or a sequence of magnetizable individual elements.

6. Process for setting up a multi-color rotary printing machine before and at the start of the print process
in which one printing plate support (1) each is assigned to the colors to be transferred onto the print substrate, whereby said printing plate support (1) supports a printing plate (6)
and in which the printing plate supports (1) are attached to mandrels or cylinders (5) of a rotary printing machine in order to transfer the print image onto the print substrate and
in which register devices (6, 7, 8) determine the position of the printing plates (6) with respect to one another,
whereby the register devices (6, 7, 8) comprise sensors (3) that determine the positions of the printing plate support (1) in the printing machine and
whereby the register devices (6, 7, 8) provide information based on the positions of the printing plate supports (1) determined by the sensors (3),
whereby control signals can be derived based on this information and
whereby the register devices (6, 7, 8) comprise a control device (7) using which it is possible to generate control signals based on the positions of the printing plate support (1) determined by the sensors (3)
and whereby the control device uses these control signals to control the drives of the mandrels or the print cylinders (5) in such a manner that the phase position of the mandrels or the print cylinders (5) in relation to one another can be changed,
so as to increase the register accuracy of the print,
and whereby printing plate supports (1) are used that each contain at least one information carrier (2) from which information can be removed using a sensor (3),
and whereby this information is read out automatically and used for determining the relative position of the printing plate support on the mandrel or on the print cylinder (5) of a rotary printing machine,
characterized in that
printing plates are used in which the information carrier (2) is arranged outside the printing plate (6) and
whereby the information carrier (2) is arranged between the print image (6) and the edge of the printing plate support that is turned toward the front end of the mandrel or of the print cylinder (5).

7. Process pursuant to claim 6 characterized in that during the adjustment of the relative phase position of the mandrels or the print cylinders, the printing plate supports (1) rest in relation to the mandrels or print cylinders (5) assigned to them.

8. Process pursuant to claim 7 characterized in that a multi-color rotary printing machine is used in which one printing plate support (1) each is assigned to the colors to be transferred onto the printing plate, whereby said printing plate support (1) supports a printing plate (6) and
said printing plate support (1) can be attached to a mandrel or a cylinder (5) of a rotary printing machine in order to transfer the print image onto the print substrate,
whereby the rotary printing machine has register devices (6, 7, 8) that determine the positions of the printing plates (6) with respect to one another and
whereby the register devices (6, 7, 8) comprise sensors (3) that determine the positions of the printing plate support (1) in the printing machine and
whereby the register devices (6, 7, 8) provide information regarding the positions of the printing plate support (1) before, at the start of or during the print process with the help of sensors (3),
based on which control signals can be provided,
whereby the register devices (6, 7, 8) comprise a control device (7) using which it is possible to generate control signals based on the positions of the printing plate support (1) determined by the sensors (3) and it is possible to control the drives of the mandrels or the print cylinders (5) using said control signals in such a manner that the phase position of the mandrels or the print cylinders (5) in relation to one another can be changed,
and the register accuracy of the print increases,
and whereby each printing plate support (1) contains at least one information carrier (2) from which information can be removed using a sensor (3), whereby the information that can be read out automatically is suitable for determining the relative position of the printing plate support on the mandrel or on the print cylinder (5) of a rotary printing machine,
characterized in
that the information carrier (2) is arranged outside the printing mandrel (6) and
that the information carrier (2) is arranged between the print image (6) and the edge of the printing plate support that is turned toward the front end of the mandrel or of the print cylinder (5).

9. Printing plate support pursuant to claim 2 characterized in that the information carrier (2) surrounds the periphery of the mandrel or the cylinder (5) of the printing machine.

10. Printing plate support pursuant to claim 2 characterized in that the information stored on the information carrier can be read out optically, magnetically or electromagnetically.

11. Printing plate support pursuant to claim 3 characterized in that the information stored on the information carrier can be read out optically, magnetically or electromagnetically.

12. Printing plate support pursuant to claim 2 characterized in that the information carrier (2) comprises a magnetic tape or a sequence of magnetizable individual elements.

13. Printing plate support pursuant to claim 3 characterized in that the information carrier (2) comprises a magnetic tape or a sequence of magnetizable individual elements.

14. Printing plate support pursuant to claim 4 characterized in that the information carrier (2) comprises a magnetic tape or a sequence of magnetizable individual elements.
